(19) United States
(12) Patent Application Publication
(10) Pub. No.: US 2013/0135366 A1
(43) Pub. Date: May 30, 2013

(54) LIQUID CRYSTAL DISPLAY DEVICE AND VEHICLE-MOUNTED INFORMATION DEVICE

(71) Applicant: Mikio Araki, Tokyo (JP)

(72) Inventor: Mikio Araki, Tokyo (JP)

(73) Assignee: MITSUBISHI ELECTRIC CORPORATION, Tokyo (JP)

(21) Appl. No.: 13/814,392

(22) PCT Filed: Dec. 24, 2010
(86) PCT No.: PCT/JP2010/007494

§ 371 Date: Feb. 5, 2013

(51) Int. Cl. G09G 3/36

(52) U.S. Cl. CPC G09G 3/3607
USPC 345/690; 345/88

(57) ABSTRACT

A liquid crystal display unit 4 has a liquid crystal screen of a curved shape and a characteristic that the viewing angle is different at each coordinate location; a correction data storage unit 2 stores a correction factor for each coordinate for correcting a color shift caused by a difference in viewing angle of the liquid crystal display unit 4, an image correction unit 1 obtains a correction factor corresponding to a coordinate of pixel data and performs a color correction, a liquid crystal driving unit 3 displays color-corrected pixel data for each coordinate at the corresponding coordinate locations on the liquid crystal screen.

### TECHNICAL FIELD

The present invention relates to a liquid crystal display device that corrects a color shift caused by a difference in viewing angle on a liquid crystal screen having a curved shape, and a vehicle-mounted information device equipped with this liquid crystal display device.

### BACKGROUND ART

One of the characteristics of liquid crystal display devices is a color shift caused by a difference in viewing angle. In a flat liquid crystal screen 101, for example, as shown in FIG. 14(a), a difference between a viewing angle θ1 at a pixel position in the center of a screen directly opposite a viewing position 100 and a viewing angle θ2 at a pixel position at an end of the screen is small. Therefore, an effect due to the color shift caused by a difference in viewing angle is small, so that a viewer can see an image without perceiving strangeness in color.

In recent years, there are some liquid crystal display devices having a curved liquid crystal screen. In a liquid crystal screen 102 curved in a vertical direction thereof, for example, as shown in FIG. 14(b), a viewing angle θ1 at a pixel position in the center of a screen directly opposite a viewing position 100 is greatly different from a viewing angle θ2 at a pixel position at an end of the screen. Therefore, there occurs a color shift caused by a difference in viewing angle, and there is a problem such that a viewer cannot see a normal image.

Patent Documents 1 and 2 are examples of conventional techniques for correcting the color and shape of the image displayed on the curved screen. In these Patent Documents 1 and 2, in a system in which a projector projects an image on a projection screen, a chromatic aberration caused on the projection screen is optically corrected, or an image distortion caused on the projection screen is corrected on image data thereof.

### PRIOR ART DOCUMENTS

### Patent Documents

Patent Document 1: Japanese Patent Application Laid-open No. 2008-113416
Patent Document 2: Japanese Patent Application Laid-open No. 2006-350370

### SUMMARY OF THE INVENTION

### Problems to be Solved by the Invention

The problem such that there occurs the color shift caused by the aforementioned difference in viewing angle is the one specific to liquid crystal display devices; especially, in the curved liquid crystal screen, an effect thereof is increased, and hence a need of making a color correction therefor is higher. However, in common flat liquid crystal screens, an effect thereof is negligible, and hence there is no need of correcting the color shift in the first place In addition, the conventional Patent Documents 1 and 2 relate to a technique for correcting optically the projected image by the projector, and are unable to correct electrically the color shift which is specific to the liquid crystal display device.

The present invention is made to solve the aforementioned problem, and an object of the invention is to provide a liquid crystal display device and a vehicle-mounted information device capable of showing a normal image to a viewer by correcting a color shift caused by a difference in viewing angle on a liquid crystal screen with a curved shape.

### Means for Solving the Problems

A liquid crystal display device of the invention is a liquid crystal display device that displays pixel data for coordinates of an input image signal at corresponding coordinate locations of a liquid crystal screen, including: a liquid crystal display unit having the liquid crystal screen of a curved shape and having a characteristic that a viewing angle varies corresponding to the coordinate locations; a correction data storage unit for storing correction factors for the coordinates and correcting a color shift caused by a difference in the viewing angle of the liquid crystal display unit; a pixel correction unit for obtaining from the correction data storage unit correction factors corresponding to the coordinates of the pixel data of the input image signal and color-correcting the pixel data by using the corresponding correction factor; and a liquid crystal driving unit for displaying the pixel data color-corrected by the pixel correction unit on the liquid crystal screen of the liquid crystal display unit.

In addition, a vehicle-mounted information device of the invention is equipped with the liquid crystal display device described above.

### Effect of the Invention

According to the invention, the pixel data to be displayed on the liquid crystal screen of a curved shape is color-corrected with the correction factor corresponding to the coordinate thereof, and therefore the color shift caused by the difference in viewing angle can be corrected, so that a liquid crystal display device capable of showing a normal image to a viewer can be provided.

Also, even in the case where the liquid crystal screen is curved in conformity with the shape of a dashboard or the like to thereby achieve a better appearance thereof, a vehicle-mounted information device capable of showing the normal image to the viewer can be provided.

### BRIEF DESCRIPTION OF THE DRAWINGS

FIG. 1 is a block diagram illustrating a configuration of a liquid crystal display device according to Embodiment 1 in the present invention.

FIG. 2 is a view illustrating a shape and coordinates of a liquid crystal display unit of the liquid crystal display device according to Embodiment 1: FIG. 2(a) is a front view; FIG. 2(b) is a side view; and FIG. 2(c) is a plan view.

FIG. 3 is a diagram showing a table of correction factors contained in a correction data storage unit of the liquid crystal display device according to Embodiment 1.

FIG. 4 is a flowchart showing an operation of the liquid crystal display device according to Embodiment 1.

FIG. 5 is a view illustrating a shape and coordinates of a liquid crystal display unit of a liquid crystal display device according to Embodiment 2 in the invention: FIG. 5(a) is a front view; FIG. 5(b) is a side view; and FIG. 5(c) is a plan view.

FIG. 6 is a diagram showing a table of correction factors contained in a correction data storage unit of the liquid crystal display device according to Embodiment 2.

FIG. 7 is a flowchart showing an operation of the liquid crystal display device according to Embodiment 2.

FIG. 8 is a view illustrating a shape and coordinates of a liquid crystal display unit of a liquid crystal display device according to Embodiment 3 in the invention: FIG. 8(a) is a front view; FIG. 8(b) is a side view; and FIG. 8(c) is a plan view.

FIG. 9 is a diagram showing a table of correction factors contained in a correction data storage unit of the liquid crystal display device according to Embodiment 3.

FIG. 10 is a flowchart showing an operation of the liquid crystal display device according to Embodiment 3.

FIG. 11 is a block diagram illustrating a configuration of a liquid crystal display device according to Embodiment 4 in the invention.

FIG. 12 is a diagram showing a table of correction factors contained in a correction data storage unit of the liquid crystal display device according to Embodiment 4.

FIG. 13 shows one example in which the liquid crystal display device according to Embodiment 4 is fitted in a dashboard of an automobile.

FIG. 14 is a diagram illustrating viewing angle characteristics of a liquid crystal display device: FIG. 14(a) shows the viewing angle characteristics of a flat liquid crystal display device; and FIG. 14(b) shows the viewing angle characteristics of a liquid crystal display device curved in a vertical direction thereof.

### BEST MODE FOR CARRYING OUT THE INVENTION

In the following, in order to describe the present invention in more detail, embodiments for carrying out the invention will be described with reference to the attached drawings.

### Embodiment 1

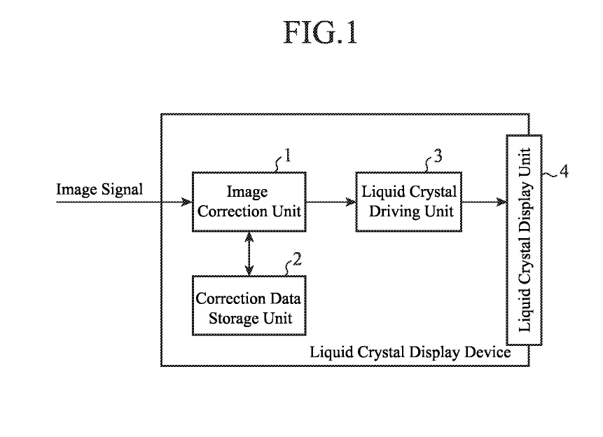

As shown in FIG. 1, a liquid crystal display device according to Embodiment 1 is composed of an image correction unit 1 that corrects pixel data of input image signals by using correction factors obtained from a correction data storage unit 2, the correction data storage unit 2 that stores the correction factors, a liquid crystal driving unit 3 that drives a liquid crystal display unit 4 by an application voltage corresponding to the corrected pixel data, and the liquid crystal display unit 4 having a liquid crystal screen of a curved shape.

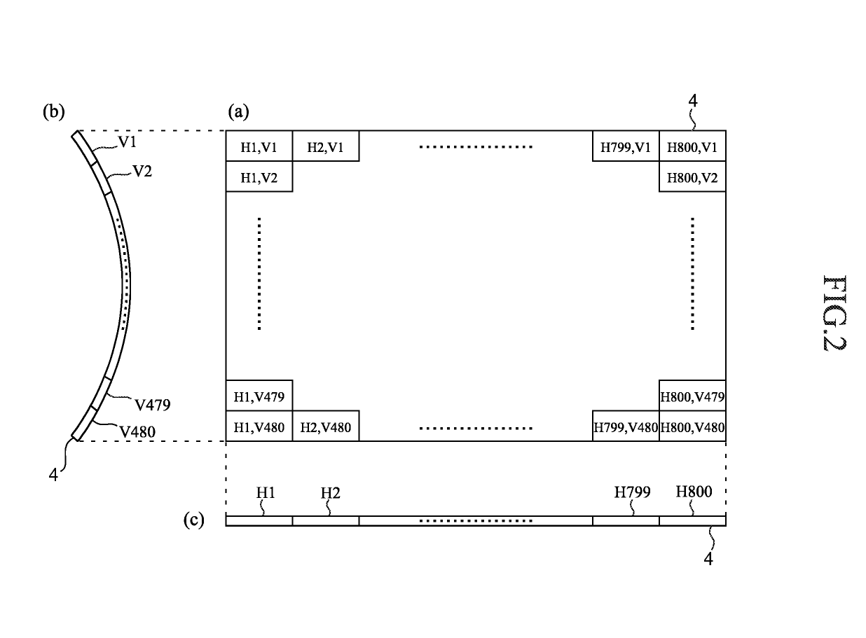

FIG. 2 is a diagram illustrating the liquid crystal display unit 4 of Embodiment 1.

FIG. 2 (a) shows a liquid crystal screen with a resolution of 800×480 pixel called WVGA (Wide Video Graphics Array). The coordinate of each pixel in this liquid crystal screen is represented by a combination of a horizontal coordinate value Hm (1≦m≦800) and a vertical coordinate value Vn (1≦n≦480). In the following, a description is given by using the WVGA as an example; however, the screen may have a resolution different from this.

Though the liquid crystal screen may have any curved shape, in Embodiment 1, by way of one example, the screen is provided with a curved shape that is curved in a vertical direction thereof as shown in FIG. 2(b). It is noted that the screen may have either of curves having convex and concave shapes toward the viewer. Also, though the screen in FIG. 2(b) is curved in a convex shape most protrusively in the vicinity of the center in the vertical direction, it is not limited to this, and any shape of the curve (radius of curvature, and so on) is acceptable.

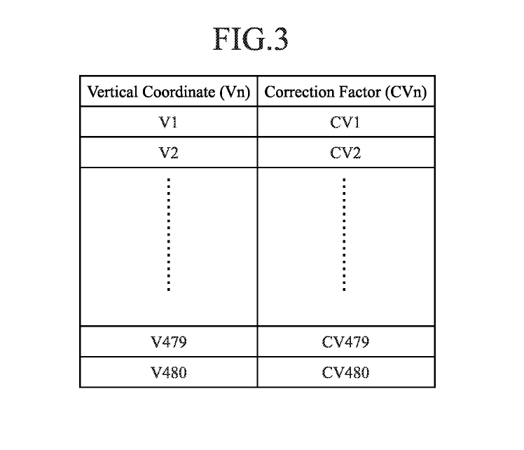

FIG. 3 is a table of correction factors contained in the correction data storage unit 2 of Embodiment 1.

Since the liquid crystal display unit 4 is curved in the vertical direction, a viewing angle is largest at the center of the liquid crystal screen and decreases toward opposite ends in the vertical direction of the liquid crystal screen. Thus, pixels different in viewing angle from one another in the vertical direction are produced. Then, the correction data storage unit 2 stores correction factors CVn for color management corresponding to the vertical coordinates Vn. This correction factor CVn is smallest in amount of correction in the vicinity of vertical coordinates V240, and increases in amount of correction corresponding to the curved shape toward vertical coordinates V1 and V480.

It is noted that the correction factor may be a factor for correcting a color component (e.g., RGB signal) contained in pixel data for each coordinate (Hm, Vn) of an input image signal, or may be a factor for correcting a gamma characteristic thereof.

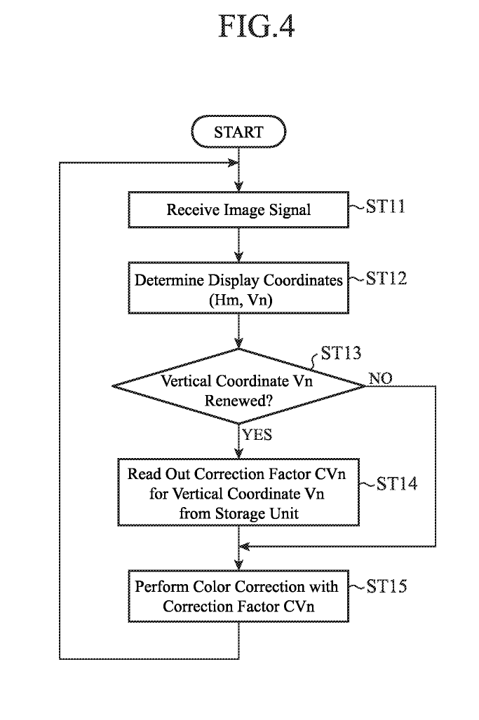

Next, an operation of the liquid crystal display device according to Embodiment 1 will be described with reference to a flowchart shown in FIG. 4.

When the image signal is input to the liquid crystal display device for each horizontal line (V1, V2, . . . , V480), the image correction unit 1 receives the image signal (step ST11), and determines a coordinate (Hm, Vn) which indicates a location on the liquid crystal screen of the liquid crystal display unit 4 (step ST12) with respect to the pixel data to be processed in the image signal.

Then, the image correction unit 1 determines whether or not the vertical coordinate Vn of the thus determined coordinate (Hm, Vn) is renewed from a previous one (step ST13), and judges that the pixel data is transferred to the next horizontal line, if the vertical coordinate Vn is renewed (step ST13 “YES”), and obtains a correction factor CVn for the next vertical coordinate Vn from the correction data storage unit 2 (step ST14). Subsequently, the image correction unit 1 performs a color correction on the pixel data (Hm, Vn) by using the obtained correction factor CVn (step ST15).

It is noted that the color correction of the pixel data with the correction factor by the image correction unit 1 may be accomplished by using a publicly known color management technique and a detailed explanation thereof will be omitted herein.

On the other hand, if the vertical coordinate Vn is not renewed (step ST13 “NO”), it is assumed that the pixel data on the same horizontal line as that of a previous color correction is to be processed, and therefore a color correction of the pixel data (Hm, Vn) is performed by using the same correction factor CVn as that used in the previous color correction (step ST15).

Specifically, the image correction unit 1 first reads out a correction factor CV1 corresponding to the vertical coordinate V1 from a correction factor table stored preliminarily in the correction data storage unit 2 with respect to a first pixel data (H1, V1) of an horizontal line (V1) to be inputted, and performs the color correction by the color management technique. Successively, the image correction unit 1 performs the color corrections with respect to pixel data (H2, V1), (H3, V1), . . . , (H800, V1) on the same horizontal line (V1) in turn by using the correction factor CV1. When the pixel data of the horizontal line (V1) where the color corrections are completed is output from the image correction unit 1 to the liquid crystal driving unit 3, the liquid crystal driving unit 3 displays the pixel data at the coordinate locations of the liquid crystal display unit 4 corresponding to the coordinates of the data.

After that, the image correction unit 1 reads out a new correction factor CV2 from the correction data storage unit 2 with respect to pixel data (H1, V2) of a next horizontal line (V2), and performs the color correction thereof.

When the above process steps are repeated, optimal color corrections can be performed on the pixels in the vertical direction in which viewing angles from a viewer are different from one another.

As described above, the liquid crystal display device according to Embodiment 1 is configured to include: the liquid crystal display unit 4 having the liquid crystal screen of the curved shape that is curved in the vertical direction and a characteristic that the viewing angle varies corresponding to the coordinate locations in the vertical direction; the correction data storage unit 2 that stores the correction factors corresponding to the coordinates in the vertical direction of the liquid crystal screen of the liquid crystal display unit 4; the image correction unit 1 that obtains the correction factor for each coordinate in the vertical direction of the pixel data from the correction data storage unit 2 and corrects the color shift caused by a difference in viewing angle in the vertical direction by using the corresponding correction factors; and the liquid crystal driving unit 3 that displays the pixel data color-corrected by the image correction unit 1 on the liquid crystal screen of the liquid crystal display unit 4. For this reason, the color shift caused by the difference in viewing angle in the vertical direction resulting from the curved liquid crystal screen in the vertical direction is corrected, so that it becomes possible to show a normal image to the viewer.

### Embodiment 2

In the above Embodiment 1, the description is given of the liquid crystal display device having the liquid crystal display unit 4 of the shape that is curved in the vertical direction as the example; however, the liquid crystal display unit 4 may have a curved shape that is curved in the horizontal direction.

FIG. 5 is a diagram illustrating a liquid crystal display unit 4 of Embodiment 2. As shown in FIG. (c), the display has a curve shape which is curved in the vertical direction. It is noted that the screen may have either of curves having convex and concave shapes toward the viewer. Also, though the screen in FIG. 5(c) is curved in a convex shape most protrusively in the vicinity of the center in the horizontal direction, it is not limited to this, and any shape of the curve is acceptable.

It is noted that the liquid crystal display device of Embodiment 2 has the same configuration in the drawings as the liquid crystal display device shown in FIG. 1, and hence it will be described below with reference to FIG. 1.

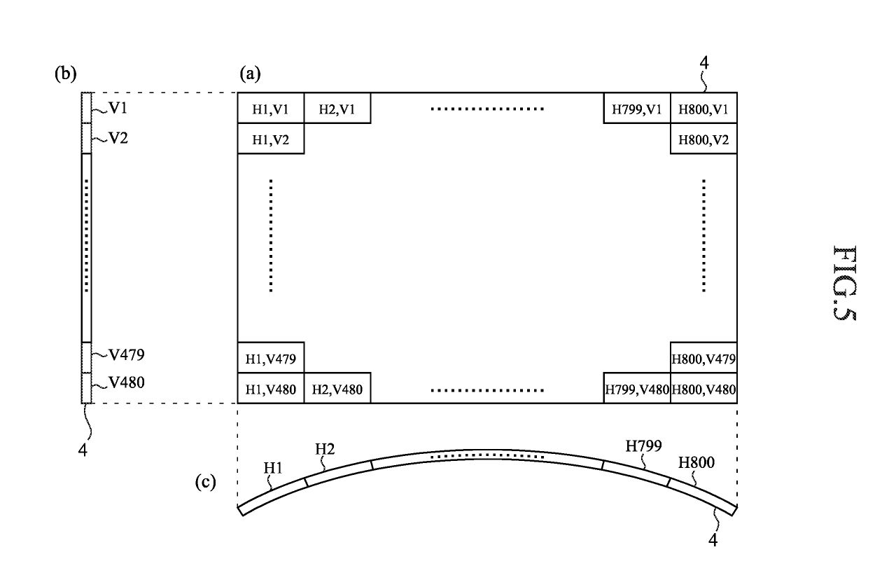

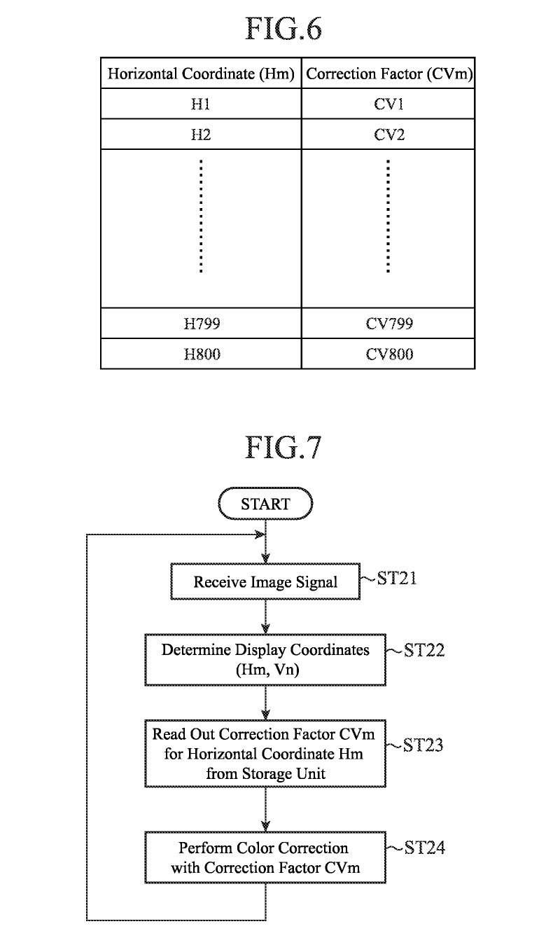

FIG. 6 is a table of correction factors contained in the correction data storage unit 2 of Embodiment 2.

Since the liquid crystal display unit 4 is curved in the horizontal direction, a viewing angle is largest at the center of the liquid crystal screen and decreases toward opposite ends in the horizontal direction of the liquid crystal screen. Thus, pixels different in viewing angle from one another in the horizontal direction are produced. Then, the correction data storage unit 2 in Embodiment 2 stores correction factors CVm for color management corresponding to horizontal coordinates Hm (1≦m≦800). This correction factor CVm is smallest in amount of correction in the vicinity of horizontal coordinates H400, and increases in amount of correction corresponding to the curved shape toward horizontal coordinates H1 and H800.

It is noted that the correction factor may be a factor for correcting a color component (e.g., RGB signal) contained in pixel data for each coordinate (Hm, Vn) of an image signal, or may be a factor for correcting a gamma characteristic thereof.

Next, an operation of the liquid crystal display device according to Embodiment 2 will be described with reference to a flowchart shown in FIG. 7.

When the image signal is input to the liquid crystal display device for each horizontal line (V1, V2, . . . , V480), the image correction unit 1 receives the image signals (step ST21), and determines a coordinate (Hm, Vn) which indicates the location on the liquid crystal screen of the liquid crystal display unit 4 with respect to pixel data to be processed in the image signals (step ST22).

Then, the image correction unit 1 obtains a correction factor CVm corresponding to the horizontal coordinate Hm of the determined coordinate (Hm, Vn) from the correction data storage unit 2 (step ST23). Subsequently, the image correction unit 1 performs a color correction of the pixel data (Hm, Vn) by using the obtained correction factor CVm (step ST24).

Specifically, the image correction unit 1 first reads out a correction factor CV1 corresponding to the horizontal coordinate H1 from a correction factor table stored preliminarily in the correction data storage unit 2 with respect to a first pixel data (H1, V1) of the input horizontal line (V1) to be inputted, and the color correction is performed by a color management technique. Successively, the image correction unit 1 reads out correction factors CV2, CV3, . . . , CV800 with respect to pixel data (H2, V1), (H3, V1), . . . , (H800, V1) on the same horizontal line (V1), respectively, and the color corrections are performed on the respective ones. When the color corrections are completed to the pixel data (H800, V1), the pixel data of the horizontal line (V1) are output from the image correction unit 1 to the liquid crystal driving unit 3, whereupon the liquid crystal driving unit 3 displays the pixel data at the coordinate locations on the liquid crystal display unit 4 corresponding to the coordinates thereof.

After that, the image correction unit 1 reads out the correction factors CV1, CV2, . . . for the pixel data of the horizontal coordinates H1, H2, . . . with respect to respective pixel data on a next horizontal line (V2), and the color corrections are performed thereon.

When the above process steps are repeated, optimal color corrections can be performed on the pixels in the horizontal direction in which viewing angles from a viewer are different from one another.

As described above, according to Embodiment 2, it is configured as follows: the liquid crystal display unit 4 of the liquid crystal display device has the liquid crystal screen of the curved shape that is curved in the horizontal direction, and a different characteristic in the viewing angle corresponding to the coordinate locations in the horizontal direction; the correction data storage unit 2 stores the correction factor for each coordinate in the horizontal direction of the liquid crystal screen; the image correction unit 1 obtains from the correction data storage unit 2 the correction factors corresponding to the coordinates in the horizontal direction of the pixel data, and corrects the color shift caused by a difference in viewing angle in the horizontal direction by using the corresponding correction factors. For this reason, the color shift caused by the difference in viewing angle in the horizontal direction resulting from the curved liquid crystal screen in the horizontal direction is corrected, so that it becomes possible to show a normal image to the viewer.

### Embodiment 3

In the above Embodiments 1 and 2, the liquid crystal display device having the liquid crystal display unit 4 of the shape that is curved toward either direction of the vertical or horizontal direction is described for the example; however, the liquid crystal display unit 4 may have a spherical shape curved in both the vertical and horizontal directions.

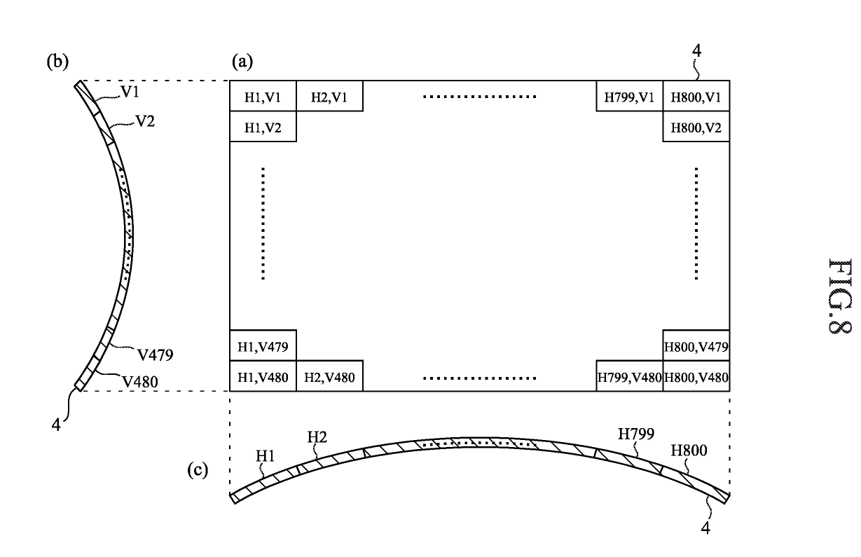

FIG. 8 is a diagram illustrating a liquid crystal display unit 4 of Embodiment 3: FIG. 8(b) is a cross-sectional view taken at horizontal coordinates H800; and FIG. 8(c) is a cross-sectional view taken at vertical coordinates V240. The liquid crystal screen may have any of a sphere having a convex shape and a sphere having a concave shape toward a viewer. Also, the screen in FIG. 8(b) and FIG. 8(c) is curved in a convex shape to be most protrusive in the vicinity of the center in the vertical and horizontal directions, it is not limited to this and the screen may have any curved shapes.

It is noted that the liquid crystal display device of Embodiment 3 has the same configuration in the drawings as the liquid crystal display device shown in FIG. 1, and hence it will be described below with reference to FIG. 1.

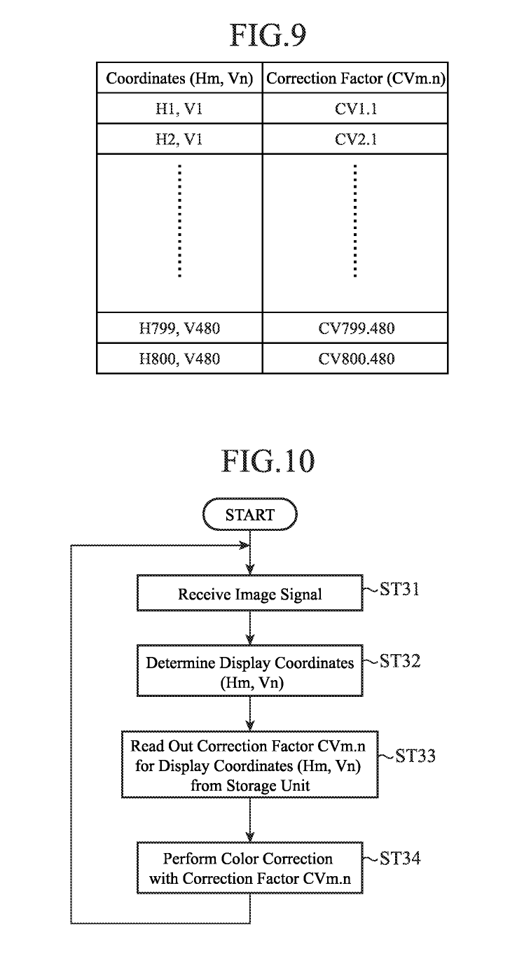

FIG. 9 is a table of correction factors contained in a correction data storage unit 2 of Embodiment 3.

Since the liquid crystal display unit 4 has a spherical shape, the viewing angle is largest at the center of the liquid crystal screen and decreases toward the ends of the four sides of the liquid crystal screen. Thus, pixels different in viewing angle are produced corresponding to coordinate locations of the liquid crystal screen. Then, the correction data storage unit 2 of Embodiment 3 stores correction factors CVm.n for color management corresponding to coordinates (Hm, Vn) represented by a combination of the horizontal coordinates Hm (1≦m≦800) and the vertical coordinates Vn (1≦n≦480). This correction factor CVm.n is smallest in amount of correction in the vicinity of a coordinate (H400, V240), and increases in amount of correction in accordance with the spherical shape toward a horizontal coordinate H1, H800 and a vertical coordinate V1, V480.

It is noted that the correction factor may be a factor for correcting a color component (e.g., RGB signal) contained in pixel data for each coordinate (Hm, Vn) of an image signal, or may be a factor for correcting a gamma characteristic thereof.

Next, an operation of the liquid crystal display device according to Embodiment 3 will be described with reference to a flowchart shown in FIG. 10.

When the image signals are input to the liquid crystal display device for each horizontal line (V1, V2, . . . , V480), the image correction unit 1 receives the image signals (step ST31), and determines the coordinate (Hm, Vn) which indicates the location on the liquid crystal screen of the liquid crystal display unit 4 with respect to pixel data to be processed in the image signals (step ST32).

Then, the image correction unit 1 obtains a correction factor CVm.n corresponding to the determined coordinate (Hm, Vn) from the correction data storage unit 2 (step ST33). Subsequently, the image correction unit 1 performs a color correction of the pixel data (Hm, Vn) by using the obtained correction factor CVm.n (step ST34).

Specifically, the image correction unit 1 first reads out a correction factor CV1.1 corresponding to a coordinate (H1, V1) from a correction factor table stored preliminarily in the correction data storage unit 2 with respect to a first pixel data (131, V1) of an horizontal line (V1) to be input, and the color correction is performed by a color management technique. Successively, the image correction unit 1 reads out correction factors CV2.1, CV3.1, . . . , CV800.1 with respect to pixel data (H2, V1), (H3, V1), . . . , (H800, V1) on the same horizontal line (V1), respectively, and the color corrections are performed on the respective ones. When the color corrections are completed to the pixel data (H800, V1), the pixel data of that horizontal line (V1) are output from the image correction unit 1 to the liquid crystal driving unit 3, whereupon the liquid crystal driving unit 3 displays the pixel data at the coordinate locations on the liquid crystal display unit 4 corresponding to the coordinates thereof.

After that, the image correction unit 1 reads out correction factors CV1.2, CV2.2, . . . for the pixel data of the respective coordinates (H1, V2), (H2, V2), . . . on a next horizontal line (V2), and the color corrections are performed thereon.

When the above process steps are repeated, optimal color corrections can be performed on the pixels in the horizontal direction in which viewing angles from a viewer are different from one another.

As described above, according to Embodiment 3, the following can be configured: the liquid crystal display unit 4 of the liquid crystal display device has the liquid crystal screen of the spherical shape and a characteristic that the viewing angle varies corresponding to the coordinate locations; the correction data storage unit 2 stores the correction factor for each coordinate of the liquid crystal screen; the image correction unit 1 obtains from the correction data storage unit 2 correction factors corresponding to the coordinates of the pixel data and corrects the color shift caused by a difference in viewing angle for each coordinate by using the corresponding correction factors. For this reason, the color shift caused by the difference in viewing angle at each coordinate location and resulting from the liquid crystal screen curved in the spherical shape is corrected, so that it becomes possible to show a normal image to the viewer.

### Embodiment 4

The liquid crystal display devices according to the above Embodiments 1 to 3 are configured to store a set of correction factor table corresponding to the shape of the liquid crystal display unit 4 in the correction data storage unit 2 beforehand; however, in Embodiment 4, the device is configured to store two or more sets of correction factor tables beforehand and to switch the correction factor tables in accordance with a predetermined condition.

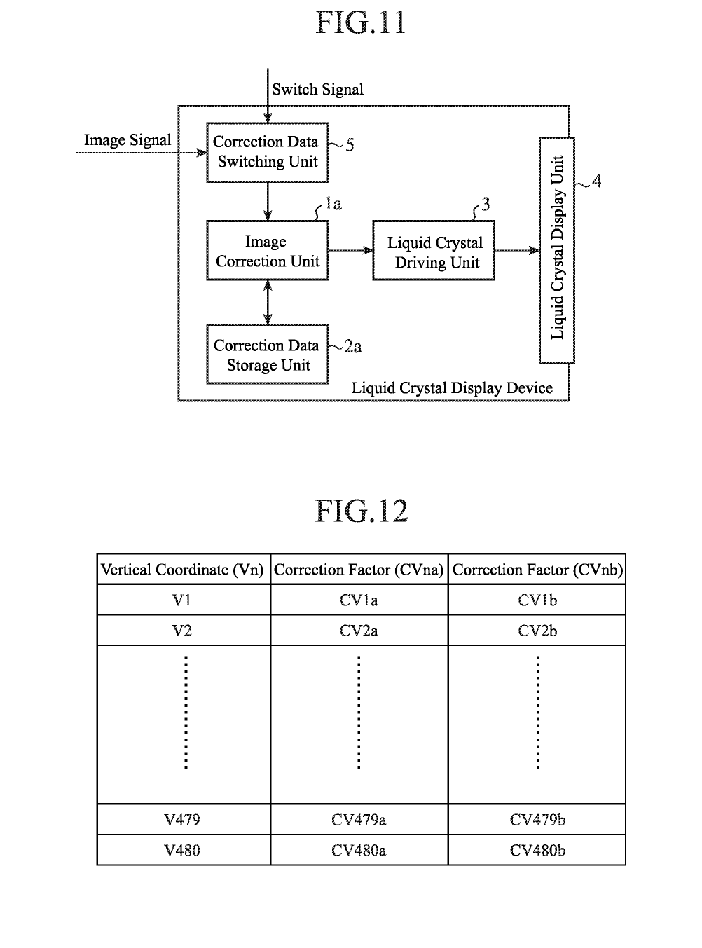

FIG. 11 is a block diagram illustrating a configuration of the liquid crystal display device according to Embodiment 4; parts that are the same as or equivalent to those of FIG. 1 are denoted by the same reference numerals and descriptions thereof will be omitted. The liquid crystal display device shown in FIG. 11 additionally includes a correction data switching unit 5 that instructs the image correction unit la to switch the correction factor tables as required in accordance with a switch signal input from the outside. Also, a correction data storage unit 2a stores the two or more sets of correction factor tables beforehand, and the image correction unit la selects the correction factor table designated by the correction data switching unit 5 from the correction data storage unit 2a and uses the table for a color correction.

FIG. 12 shows one example of the correction data storage unit 2a. The correction data storage unit 2a stores beforehand two correction factor tables of correction factors CVna, CVnb corresponding to a vertical coordinate Vn.

For example, when the mounting angles of the liquid crystal display unit 4 differ, viewing angle characteristics thereof also change; thus, the correction factor CVna for correcting the viewing angle characteristics associated with a mounting angle a, and the correction factor CVnb for correcting the viewing angle characteristics associated with a mounting angle b are stored in the correction data storage unit 2a, and the correction data switching unit 5 receives a switch signal designating either of the mounting angles a and b from the outside and instructs either of the correction factors CVna and CVnb to the image correction unit la. In this manner, the image correction unit la can perform optimally the color correction by using the correction factor CVna in the case of the liquid crystal display unit 4 at the mounting angle a, and can perform optimally the color correction by using the correction factor CVnb in the case of the liquid crystal display unit 4 at the mounting angle b.

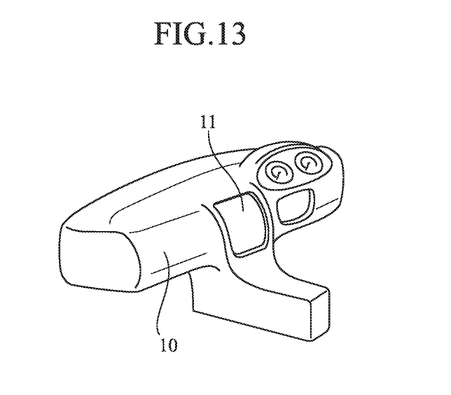

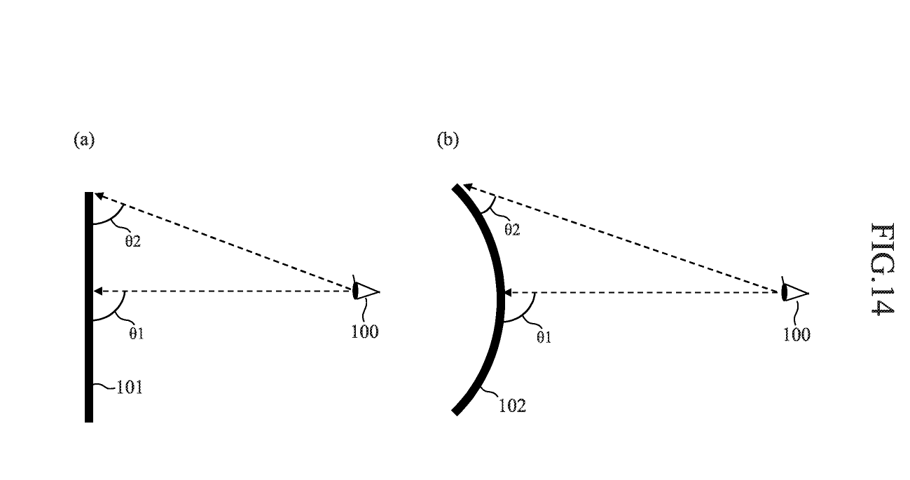

In addition, for example, the device may be configured that a viewer selects an image that is subjected to a desired color correction by switching the two or more sets of correction factor tables to be displayed in the liquid crystal display unit 4. FIG. 13 shows one example in which the liquid crystal display device is fitted in a dashboard 10 of an automobile. The liquid crystal screen 11 in the drawing corresponds to the liquid crystal screen of the liquid crystal display unit 4. This liquid crystal screen 11 has a shape curved in the vertical direction to conform to the curved shape of the dashboard 10 to thereby achieve a better appearance by a unity of the curved shapes. The viewing position differs depending on the viewer (driver); thus, respective correction factor tables corresponding to a plurality of viewing positions (for example, correction factors CVna, CVnb in FIG. 12) are stored in the correction data storage unit 2a beforehand, and the correction data switching unit 5 outputs an instruction to switch the correction factor tables corresponding to a switch signal instructed by the viewer; the image correction unit la obtains the correction factor table corresponding to the instruction from the correction data storage unit 2a to use the table for the color correction.

Further, though it is configured that the correction data storage unit 2a stores the two correction factor tables in the above example, it goes without saying that the storage unit may be configured to store three or more correction factor tables. Also, in the case where the liquid crystal display unit 4 has a liquid crystal screen curved in the horizontal direction, or curved in a spherical shape, the storage unit has only to store a plurality of correction factor tables corresponding to viewing angle characteristics of those shapes.

As described above, according to Embodiment 4, the following is configured: the correction data storage unit 2a stores a plurality of pairs of the mounting angle of the liquid crystal screen and the correction factor for each coordinate corresponding to the corresponding mounting angle; and the image correction unit la obtains from the correction data storage unit 2a the correction factor corresponding to the mounting angle provided from the outside via the correction data switching unit 5 to be used for the color correction. For this reason, it becomes possible to show a normal image to the viewer, irrespective of the mounting angle of the liquid crystal display device.

Furthermore, according to Embodiment 4, it is configured that the correction data storage unit 2a stores the plurality of correction factors for each coordinate, and that the image correction unit la obtains from the correction data storage unit 2a the correction factor corresponding to the instruction of the viewer and provided via the correction data switching unit 5 to be used for the color correction. For this reason, it becomes possible to show the normal image to the viewer, irrespective of the viewing position.

Incidentally, in the above Embodiments 1 to 4, though the liquid crystal screen that is curved in the curved or spherical shape is described as the example, it is not limited to this, and may have a freely curved surface, for example. In this case, the correction data storage unit 2, 2a have only to store the correction factors corresponding to the freely curved shape so that the color shifts depending on the viewing angles at the coordinates can be corrected.

In addition to the above, according to the present invention, within the scope of the invention, the embodiments can be freely combined, or any components in the embodiments can be modified or any components in the embodiments can be omitted.

### INDUSTRIAL APPLICABILITY

As described above, the liquid crystal display device according to the present invention corrects the color shift caused by the difference in viewing angle on the liquid crystal screen with the curved shape, and therefore it is suitable for use in vehicle-mounted information devices such as vehicle-mounted displays, vehicle-mounted audio/video devices, vehicle-mounted navigation devices, and so on curved in conformity with the shape of a dashboard.

### EXPLANATION OF REFERENCE NUMERALS

1, 1a: image correction unit

2, 2a: correction data storage unit

3: liquid crystal driving unit

4: liquid crystal display unit

5: correction data switching unit

10: dashboard

11: liquid crystal screen

100: viewing position

101: flat liquid crystal screen

102: curved liquid crystal screen

θ1, θ2: viewing angle

1. A liquid crystal display device that displays pixel data for coordinates of an input image signal at corresponding coordinate locations of a liquid crystal screen, comprising:
a liquid crystal display unit having said liquid crystal screen of a curved shape and having a characteristic that a viewing angle varies corresponding to the coordinate locations;
a correction data storage unit for storing correction factors for the coordinates and correcting a color shift caused by a difference in the viewing angle of said liquid crystal display unit;
a pixel correction unit for obtaining from said correction data storage unit correction factors corresponding to the coordinates of the pixel data of said input image signal and color-correcting said pixel data by using the corresponding correction factor; and
a liquid crystal driving unit for displaying the pixel data color-corrected by said pixel correction unit on the liquid crystal screen of said liquid crystal display unit.

2. The liquid crystal display device according to claim 1, wherein the liquid crystal screen of said liquid crystal display unit has a curved shape curved in a vertical direction thereof,
said correction data storage unit stores the correction factors for the coordinates in the vertical direction of said liquid crystal screen, and
said image correction unit obtains the correction factor corresponding to the coordinate in the vertical direction of the pixel data from said correction data storage unit, and corrects the color shift caused by a difference in the viewing angle in the vertical direction by using the corresponding correction factor.

3. The liquid crystal display device according to claim 1, wherein the liquid crystal screen of said liquid crystal display unit has a curved shape curved in a horizontal direction thereof,
said correction data storage unit stores the correction factors for the coordinates in the horizontal direction of said liquid crystal screen, and
said image correction unit obtains the correction factor corresponding to the coordinate in the horizontal direction of the pixel data from said correction data storage unit, and corrects the color shift caused by a difference in the viewing angle in the horizontal direction by using the corresponding correction factor.

4. The liquid crystal display device according to claim 1, wherein the liquid crystal screen of said liquid crystal display unit has a spherical shape,
said correction data storage unit stores the correction factors for the coordinates of said liquid crystal screen, and
said image correction unit obtains the correction factor corresponding to the coordinate of the pixel data from said correction data storage unit, and corrects the color shifts caused by a difference in the viewing angle for the coordinates by using the corresponding correction factor.

5. The liquid crystal display device according to claim 1, wherein said correction data storage unit stores a plurality of pairs of mounting angles of said liquid crystal screen and the correction factors for the coordinates corresponding to the corresponding mounting angles, and
said image correction unit obtains from said correction data storage unit the correction factors corresponding to a mounting angle provided from outside and uses the resultant for a color correction.

6. The liquid crystal display device according to claim 1, wherein said correction data storage unit stores a plurality of correction factors for the coordinates, and
said image correction unit obtains from said correction data storage unit the correction factors according to an instruction from a viewer and uses the resultant for a color correction.

7. The liquid crystal display device according to claim 1, wherein said correction factor is a value for correcting a color component of the pixel data.

8. The liquid crystal display device according to claim 1, wherein said correction factor is a value for correcting a gamma characteristic of the pixel data.

9. A vehicle-mounted information device equipped with the liquid crystal display device according to claim 1.
